(19) United States
(12) Patent Application Publication
(10) Pub. No.: US 2007/0251522 A1
(43) Pub. Date: Nov. 1, 2007

(54) Respirator with exhalation vents

(76) Inventors: Debra N. Welchel, Woodstock, GA (US); Megan C. H. Smith, Roswell, GA (US); Kiran K. Reddy, Roswell, GA (US); Herb F. Velazquez, Neenah, WI (US); Eric C. Steindorf, Roswell, GA (US); Timothy J. Peters, Neenah, WI (US); Russell J. Kroll, Atlanta, GA (US); Philip D. Palermo, Marietta, GA (US); Suzuko Hisata, Atlanta, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/638,831

(22) Filed: Dec. 14, 2006

Related U.S. Application Data
(60) Provisional application No. 60/796,994, filed on May 1, 2006.

(51) Int. Cl. A62B 18/08

(52) U.S. Cl. 128/201.15

(57) ABSTRACT

A respirator adapted to facilitate ease of donning and comfort during use comprising one or more of an adjustable or elastic strap that facilitates ease of donning and comfort during wear; and/or exhalation vents that direct exhaled air, at least in part, away from a users eye's; and/or fasteners that are easy to use and that facilitate ease of donning and comfort during wear; and/or respirator shapes that facilitate the wearing of eyeglasses with said respirator; and/or bellows-type, pneumatic, or other such components, associated with said respirator, that are adapted to promote adjustability of the fit of the respirator.

This application claims priority to, and incorporates by reference in its entirety, U.S. Provisional Patent Application No. 60/796,994 filed on 1 May 2006.

### BACKGROUND

Respirators find utility in a variety of manufacturing, custodial, sporting, and household applications. In these types of applications, respirators filter out dust and other contaminates to facilitate easier breathing on the part of the user. Likewise, respirators have found utility in the healthcare industry. In this regard, respirators are helpful in that they may be configured to filter exhaled air from the wearer to minimize the amount of bacteria or other contaminants released from the user into the environment. Such a limitation of bacteria contaminants is important in that hospital patients typically require a sterile environment in order to avoid infections, and hospital patients often have compromised immune systems making them susceptible to infection. Additionally, respirators may also filter inhaled air to protect the user from contaminants that may be found in a hospital setting, as hospital patients commonly carry airborne bacterial pathogens.

It is therefore the case that in the health care field, specifically in operating rooms, health care providers often use respirators to help protect themselves from acquiring harmful diseases such as AIDS and hepatitis along with other contagious diseases that may be present in the patients that are being treated.

Respirators have also been designed in order to provide a tight sealing arrangement. Such a sealing arrangement may prove useful in preventing the transfer of pathogens that reside in bodily fluids or other liquids. As such, respirators have been designed in order to prevent airborne pathogens and/or pathogens in fluids from being transferred to and/or from the health care provider. Such sealing arrangements can be used to help keep out dust, particles, or other contaminants from air being inhaled by a wearer (i.e., the respirator acts to filter or otherwise help keep out such materials, dust, or contaminants as air passes through the respirator).

Some respirators are configured to cover the entire face of a user while other respirators are designed to cover only the nose and mouth of the user. Additionally, respirators have been designed to cover various parts of a user's face. For instance, certain respirators are configured for covering the nose, eyes, and mouth of a user. The section of the respirator that covers the nose and mouth typically is composed of a material that prevents the passage of germs and other contaminants therethrough but allows for the passage of air so that the user may breathe. Attached to the respirator is a securing device that is used for attaching the front panel securely to the head of the user. For instance, manual tie straps might be employed, especially for health-care respirators. For this purpose, the respirator is placed on the face of the user and the tie straps are extended around the head of the user and tied. The straps fasten the respirator to the user.

Currently, disposable respirators, especially those used for industrial or related purposes, most typically incorporate two thin elastic bands that are intended to span the back and top of the wearer's head to ensure a close and tight fit. These bands are difficult to place correctly and frequently slide, roll, or slip out of place. Furthermore, such respirators may allow air being expelled from a user's lungs during exhalation to migrate or be directed to or around the user's eyes (e.g., if the main body of the respirator fails to seal appropriately around its perimeter against the wearer's skin—this is generally more likely to occur during facial movements of the wearer). If the user is wearing eyewear, e.g., safety glasses, then such air, which is laden with moisture, may cause condensation on the surfaces of the eyewear, potentially making it more difficult to see. Also, current respirator designs may impede downward and peripheral vision.

What is needed are respirators (and sub-assemblies thereof directed to one or more of the following components) comprising: an adjustable or elastic strap that facilitates ease of donning and comfort during wear; and/or exhalation vents that direct exhaled air, at least in part, away from a users eye's; and/or fasteners that are easy to use and that facilitate ease of donning and comfort during wear; and/or respirator shapes that facilitate the wearing of eyeglasses with said respirator; and/or bellows-type components in or part of the strap, or other such components in or part of the strap, that are adapted to promote adjustability of the fit of the respirator; and/or a respirator portion that is capable of expanding outward during use from a flatter state during storage or shipment (e.g., by having the main body of the respirator in a somewhat accordion-like or bellows-like configuration during shipment and storage, but adapted to expand outward during use of said respirator; or by having the main body of the respirator capable of folding—such as in half—so that the main body of the respirator can be shipped or stored in a relatively flat position, but adapted to open/expand for use).

### SUMMARY

We have determined that a number of unique design configurations may help facilitate improved donning, fit, adjustment, seal, comfort, style/aesthetics and/or straps.

Various features and advantages of the invention will be set forth in part in the following description.

### BRIEF DESCRIPTION OF THE DRAWINGS

FIG. 1 is a view of one representative version of a respirator of the present invention.

FIG. 2 is a view of one representative version of a respirator of the present invention.

FIG. 3 is a view of one representative version of a respirator of the present invention.

FIG. 4 is a view of one representative version of a respirator of the present invention.

FIG. 5 is a view of one representative version of a respirator of the present invention.

FIG. 6 is a view of one representative version of a respirator of the present invention.

FIG. 7 is a view of a representative version of an exhalation vent of the present invention.

FIG. 8 is a view of a representative version of an exhalation vent of the present invention.

### DEFINITIONS

Within the context of this specification, each term or phrase below includes the following meaning or meanings:

“Attach” and its derivatives refer to the joining, adhering, connecting, bonding, sewing together, or the like, of two elements. Two elements will be considered to be attached together when they are integral with one another or attached directly to one another or indirectly to one another, such as when each is directly attached to intermediate elements. “Attach” and its derivatives include permanent, releasable, or refastenable attachment. In addition, the attachment can be completed either during the manufacturing process or by the end user.

“Autogenous bonding” and its derivatives refer to bonding provided by fusion and/or self-adhesion of fibers and/or filaments without an applied external adhesive or bonding agent. Autogenous bonding may be provided by contact between fibers and/or filaments while at least a portion of the fibers and/or filaments are semi-molten or tacky. Autogenous bonding may also be provided by blending a tackifying resin with the thermoplastic polymers used to form the fibers and/or filaments. Fibers and/or filaments formed from such a blend can be adapted to self-bond with or without the application of pressure and/or heat. Solvents may also be used to cause fusion of fibers and filaments which remains after the solvent is removed.

“Bond,” “interbond,” and their derivatives refer to the joining, adhering, connecting, attaching, sewing together, or the like, of two elements. Two elements will be considered to be bonded or interbonded together when they are bonded directly to one another or indirectly to one another, such as when each is directly bonded to intermediate elements. “Bond” and its derivatives include permanent, releasable, or refastenable bonding. “Autogenous bonding,” as described above, is a type of “bonding.”

“Connect” and its derivatives refer to the joining, adhering, bonding, attaching, sewing together, or the like, of two elements. Two elements will be considered to be connected together when they are connected directly to one another or indirectly to one another, such as when each is directly connected to intermediate elements. “Connect” and its derivatives include permanent, releasable, or refastenable connection. In addition, the connecting can be completed either during the manufacturing process or by the end user.

“Coform” refers to a blend of meltblown fibers and absorbent fibers such as cellulosic fibers that can be formed by air forming a meltblown polymer material while simultaneously blowing air-suspended fibers into the stream of meltblown fibers. The coform material may also include other materials, such as superabsorbent materials. The meltblown fibers and absorbent fibers are collected on a forming surface, such as provided by a belt. The forming surface may include a gas-pervious material that has been placed onto the forming surface. Two U.S. patents describing coform materials are U.S. Pat. No. 100,324 to Anderson et al. and U.S. Pat. No. 5,350,624 to Georger et al., both of which are incorporated in their entirety in a manner consistent herewith.

“Disposable” refers to articles that are designed to be discarded after a limited use rather than being restored for reuse.

The terms “disposed on,” “disposed along,” “disposed with,” or “disposed toward” and variations thereof are intended to mean that one element can be integral with another element, or that one element can be a separate structure bonded to or placed with or placed near another element.

“Layer” when used in the singular can have the dual meaning of a single element or a plurality of elements.

“Meltblown” refers to fibers formed by extruding a molten thermoplastic material through a plurality of fine, usually circular, die capillaries as molten threads or filaments into converging high velocity gas (e.g., air) streams, generally heated, which attenuate the filaments of molten thermoplastic material to reduce their diameters. Thereafter, the meltblown fibers are carried by the high velocity gas stream and are deposited on a collecting surface or support to form a web of randomly dispersed meltblown fibers. Such a process is disclosed, for example, in U.S. Pat. No. 3,849,241 to Butin et al. Meltblowing processes can be used to make fibers of various dimensions, including macrofibers (with average diameters from about 40 to about 100 microns), textile-type fibers (with average diameters between about 10 and 40 microns), and microfibers (with average diameters less than about 10 microns). Meltblowing processes are particularly suited to making microfibers, including ultra-fine microfibers (with an average diameter of about 3 microns or less). A description of an exemplary process of making ultra-fine microfibers may be found in, for example, U.S. Pat. No. 5,213,881 to Timmons, et al. Meltblown fibers may be continuous or discontinuous and are generally self bonding when deposited onto a collecting surface.

“Nonwoven” and “nonwoven web” refer to materials and webs of material that are formed without the aid of a textile weaving or knitting process. For example, nonwoven materials, fabrics or webs have been formed from many processes such as, for example, meltblowing processes, spunbonding processes, air laying processes, coform processes, and bonded carded web processes.

“Operatively connected” refers to the communication pathway by which one element, such as a sensor, communicates with another element, such as an information device. Communication may occur by way of an electrical connection through a conductive wire. Or communication may occur via a transmitted signal such as an infrared frequency, a radio frequency, or some other transmitted frequency signal. Alternatively, communication may occur by way of a mechanical connection, such as a hydraulic or pneumatic connection.

“Spunbonded fibers” refers to small diameter fibers which are formed by extruding molten thermoplastic material as filaments from a plurality of fine, usually circular capillaries of a spinneret with the diameter of the extruded filaments then being rapidly reduced to fibers as by, for example, in U.S. Pat. No. 4,340,563 to Appel et al., and U.S. Pat. No. 3,692,618 to Dorschner et al. , U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al., the contents of which are incorporated herein by reference in their entirety. Spunbond fibers are generally continuous and have diameters generally greater than about 7 microns, more particularly, between about 10 and about 20 microns.

“Stretch bonded laminate” refers to a composite material having at least two layers in which one layer is a gatherable layer and the other layer is an elastic layer. The layers are joined together when the elastic layer is extended from its original condition so that upon relaxing the layers, the gatherable layer is gathered. Such a multilayer composite elastic material may be stretched to the extent that the nonelastic material gathered between the bond locations allows the elastic material to elongate. One type of stretch bonded laminate is disclosed, for example, by U.S. Pat. No. 4,720,415 to Vander Wielen et al., the content of which is incorporated herein by reference in its entirety. Other composite elastic materials are disclosed in U.S. Pat. No. 4,789,699 to Kieffer et al., U.S. Pat. No. 4,781,966 to Taylor and U.S. Pat. Nos. 4,657,802 and 4,652,487 to Morman and U.S. Pat. No 4,655,760 to Morman et al., the contents of which are incorporated herein by reference in their entirety.

“Necking” or “neck stretching” interchangeably refer to a method of elongating a nonwoven fabric, generally in the machine direction, to reduce its width (cross-machine direction) in a controlled manner to a desired amount. The controlled stretching may take place under cool, room temperature or greater temperatures and is limited to an increase in overall dimension in the direction being stretched up to the elongation required to break the fabric, which in most cases is about 1.2 to 1.6 times. When relaxed, the web retracts toward, but does not return to, its original dimensions. Such a process is disclosed, for example, in U.S. Pat. No. 4,443,513 to Meitner and Notheis, U.S. Pat. Nos. 4,965,122, 4,981,747 and 5,114,781 to Morman and U.S. Pat. No. 5,244,482 to Hassenboehier Jr. et al., the contents of which are incorporated herein by reference in their entirety.

“Necked material” refers to any material which has undergone a necking or neck stretching process.

“Reversibly necked material” refers to a material that possesses stretch and recovery characteristics formed by necking a material, then heating the necked material, and cooling the material. Such a process is disclosed in U.S. Pat. No. 4,965,122 to Morman, commonly assigned to the assignee of the present invention, and incorporated by reference herein in its entirety. As used herein, the term “neck bonded laminate” refers to a composite material having at least two layers in which one layer is a necked, non-elastic layer and the other layer is an elastic layer. The layers are joined together when the non-elastic layer is in an extended (necked) condition. Examples of neck-bonded laminates are such as those described in U.S. Pat. Nos. 5,226,992, 4,981,747, 4,965,122 and 5,336,545 to Morman, the contents of which are incorporated herein by reference in their entirety.

“Stitchbonded” refers to a process in which materials (fibers, webs, films, etc.) are joined by stitches sewn or knitted through the materials. Examples of such processes are illustrated in U.S. Pat. No. 4,891,957 to Strack et al. and U.S. Pat. No. 4,631,933 to Carey, Jr., the contents of which are incorporated herein by reference in their entirety.

“Ultrasonic bonding” refers to a process in which materials (fibers, webs, films, etc.) are joined by passing the materials between a sonic horn and anvil roll. An example of such a process is illustrated in U.S. Pat. No. 4,374,888 to Bornslaeger, the content of which is incorporated herein by reference in its entirety.

“Thermal point bonding” involves passing materials (fibers, webs, films, etc.) to be bonded between a heated calender roll and an anvil roll. The calender roll is usually, though not always, patterned in some way so that the entire fabric is not bonded across its entire surface, and the anvil roll is usually flat. As a result, various patterns for calender rolls have been developed for functional as well as aesthetic reasons. Typically, the percent bonding area varies from around 10 percent to around 30 percent of the area of the fabric laminate. As is well known in the art, thermal point bonding holds the laminate layers together and imparts integrity to each individual layer by bonding filaments and/or fibers within each layer.

“Elastic” refers to any material, including a film, fiber, nonwoven web, or combination thereof, which upon application of a biasing force in at least one direction, is stretchable to a stretched, biased length which is at least about 110 percent, suitably at least about 130 percent, and particularly at least about 150 percent, its relaxed, unstretched length, and which will recover at least 15 percent of its elongation upon release of the stretching, biasing force. In the present application, a material need only possess these properties in at least one direction to be defined as elastic.

“Extensible and retractable” refers to the ability of a material to extend upon stretch and retract upon release. Extensible and retractable materials are those which, upon application of a biasing force, are stretchable to a stretched, biased length and which will recover a portion, preferably at least about 15 percent, of their elongation upon release of the stretching, biasing force.

As used herein, the terms “elastomer” or “elastomeric” refer to polymeric materials that have properties of stretchability and recovery.

“Stretch” refers to the ability of a material to extend upon application of a biasing force. Percent stretch is the difference between the initial dimension of a material and that same dimension after the material has been stretched or extended following the application of a biasing force. Percent stretch may be expressed as [(stretched length—initial sample length)/initial sample length]×100. For example, if a material having an initial length of one (1) inch is stretched 0.50 inch, that is, to an extended length of 1.50 inches, the material can be said to have a stretch of 50 percent.

“Recover” or “recovery” refers to a contraction of a stretched material upon termination of a biasing force following stretching of the material by application of the biasing force. For example, if a material having a relaxed, unbiased length of one (1) inch is elongated 50 percent by stretching to a length of one and one half (1.5) inches the material would have a stretched length that is 150 percent of its relaxed length. If this exemplary stretched material contracted, that is recovered to a length of one and one tenth (1.1) inches after release of the biasing and stretching force, the material would have recovered 80 percent (0.4 inch) of its elongation.

“Electret” or “electret treating” refers to a treatment that imparts a charge to a dielectric material, such as a polyolefin. The charge includes layers of positive or negative charges trapped at or near the surface of the polymer, or charge clouds stored in the bulk of the polymer. The charge also includes polarization charges which are frozen in alignment of the dipoles of the molecules. Methods of subjecting a material to electret treating are well known by those skilled in the art. These methods include, for example, thermal, liquid-contact, electron beam, and corona discharge methods. One particular technique of subjecting a material to electret treating is disclosed in U.S. Pat. No. 5,401,466, the contents of which is herein incorporated in its entirety by reference. This technique involves subjecting a material to a pair of electrical fields wherein the electrical fields have opposite polarities.

“Polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

These terms may be defined with additional language in the remaining portions of the specification.

### DESCRIPTION

Reference will now be made in detail to embodiments of the invention, one or more examples of which are illustrated in the drawings. Each example is provided by way of explanation of the invention, and is not meant as a limitation of the invention. For example, features illustrated or described as part of one embodiment can be used with another embodiment to yield still a third embodiment. It is intended that the present invention include these and other modifications and variations.

It is to be understood that the ranges and limits mentioned herein include all ranges located within, and also all values located under or above the prescribed limits. For instance, a range from about 100 to 200 also includes ranges from 110 to 150, 170 to 190, and 153 to 162. Further, a limit of up to about 7 also includes a limit of up to about 5, up to 3, and up to about 4.5.

As noted above, many current respirators are deemed uncomfortable or difficult to don and use. One component of a respirator that impacts comfort and ease of use are the straps which help position and hold the main body of the respirator on a wearer's face. As noted above, frequently two thin elastic bands are integrally attached to the main body of a respirator, especially a respirator designed for industrial-type applications. These two straps are intended to encircle the back and top of a wearer's head to help facilitate a close, tight fit. Unfortunately, such bands are difficult to place correctly and frequently slide, roll, or slip out of place.

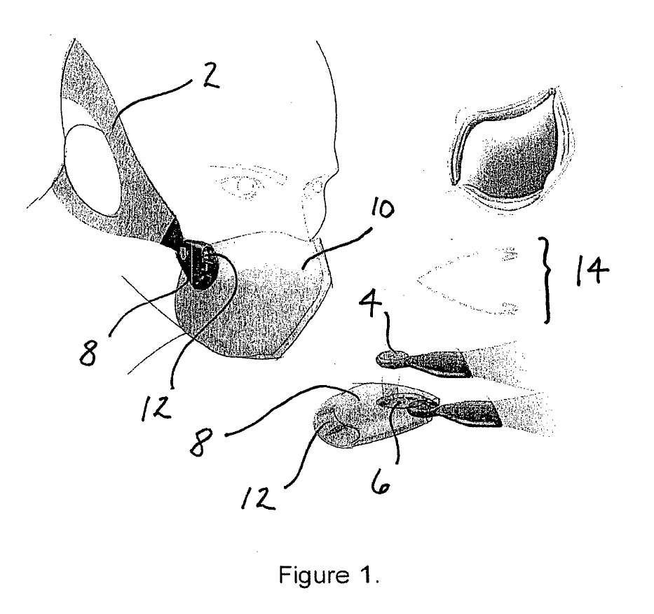

Respirators of the present invention comprise straps of innovative materials, geometries, and/or attachment devices (i.e., fasteners or fastening systems). For example, a number of representative embodiments of the present invention comprise straps that can releasably connect or fasten to the respirator, thereby allowing the user to more conveniently don the mask. See, for example, the representative embodiments depicted in FIGS. 1, 2, 3, 4, 5, and 8. In each of these representative embodiments, one or both ends of the strap are not integrally connected to the main body of the respirator (i.e., that portion of the respirator adapted to filter, screen, or otherwise affect at least a portion of one or more constituents in air or gas being inhaled or exhaled through the respirator). In some embodiments, the width of the strap is selected so that the strap is less prone to roll or shift (e.g., strap 2 as depicted in FIG. 1). In some embodiments of the invention, at least some portion of the strap has a width between about 0.5 cm and about 5 cm. In other embodiments of the invention, at least some portion of the strap has a width between about 0.3 cm and about 3 cm. Note also, as depicted in FIG. 1, the strap portion may split into two or more bands to facilitate stabilization of the respirator during use. Here the strap portion splits at the wearer's ear to form, in effect, a sideways Y-shaped strap portion, or Y-shaped junction, with the wearer's ear proximate to the location at which the strap splits into two bands, one band going under the ear, and one band going over the ear.

Different fastening systems may be used. In some of the depicted embodiments, the strap comprises a flexible material adapted to encircle the head (e.g., a nonwoven material adapted to stretch). The strap comprising this material is attached, at its ends, to a strap fastening component that can releasably engage a corresponding fastening component on the main body of the respirator. The strap fastening component may be attached to the strap in any number of ways know to those in the art (e.g., using adhesive; welding; by inputting thermal or other energy to fuse the materials; by using mechanical fastening elements to attach the strap to the strap fastening component—e.g., screws, rivets, snaps, hook-and-loop fasteners, etc.; or other such methods or combinations of methods, so long as the strap fastening component remains attached to the strap during use of the respirator with which the strap and strap fastening component are being employed). The fastening component, which is adapted to releasably engage the strap fastening component, may be attached to the main body of the respirator using the same or similar approaches. The fastening component, which is adapted to releasably engage the strap fastening component, may be attached to the main body of the respirator using the same or similar approaches. The main body of the respirator, or portions thereof, may be shaped or cut (including the cutting of openings in said main body that are adapted to receive at least a portion of, for example, a fastening component).

In one version of the present invention, the strap fastening component is sufficiently rigid shape, such as a disk, square, or other geometry, that can releasably engage or attach to a fastening component on the main body of the respirator. One example of a fastening component on the main body of the respirator is a sufficiently rigid shape having an opening through which the strap fastening component can be inserted; and a cavity into which the strap fastening component (e.g., a disk, square, or other geometry) can be inserted and held in place (by, e.g., the tension of the strap pulling the strap fastening component into a recess or slot or other shape that helps hold the respirator and strap in place while the device is being worn; of course other approaches may be used to help hold the strap fastening component in place, such as magnetic forces, hook-and-loop fasteners, adhesive, metal or plastic snaps, buckles, etc.). In the representative embodiment depicted in FIG. 1, the strap fastening component is a disk 4 capable of being inserted into an opening 6 in the fastening component 8, with the fastening component 8 attached to the main body of the respirator 10.

In some embodiments, the fastening component on the main body of the respirator is also adapted to act as an exhalation vent (i.e., vents to facilitate the channeling of exhaled air through the fastening component on the main body of the respirator and outward into the external environment). In FIG. 1, the exhalation vent comprises channels 12 through which air is conducted. In some embodiments, these vents facilitate movement of exhaled air away from the eyes of the wearer, thereby serving to reduce the amount of moisture-laden, exhaled air getting between the eyes of the wearer, and any eyeglasses worn by the wearer. Furthermore, such vents can provide for a greater volumetric flow rate of exhaled air to be conducted through the vents, rather than outward through the main body of the respirator. In some cases, the vents, ports, channels, or openings may be covered, e.g., with a porous or filter media, to reduce the amount of certain constituents in exhaled air escaping into the surrounding environment. In other versions of the invention, the ports, channels, or other openings that comprise an exhalation vent may be rotated or altered so that the direction of the exhaled air can be changed by a wearer of the respirator. For example, channels could be set in a disk that is in fluid communication with the volume between the wearer's face and the interior surface of the respirator, with said disk adapted to rotate within a housing that makes up the exhalation assembly (or, as is described above, in a fastening component attached to the respirator, with the fastening component serving as both a receiver of the corresponding strap fastening component, and as an exhalation vent). Alternatively, the entire fastening component attached to the main body of the respirator may be adapted to pivot or rotate relative to the main body of the respirator itself. Other configurations may be selected, so long as, for those versions of the present invention incorporating an adjustable exhalation vent, the ports, channels, openings, or other configuration making up the vent are adapted to rotate or pivot so as to change the direction of any air or gas being expelled through the vent due to a wearer of the respirator exhaling.

In some embodiments, the main body of the respirator comprises two fastening components (identified with designator 8 in the representative embodiment depicted in FIG. 1), with each fastening component on the main body of the respirator located proximate to the sides of the wearer's face when the respirator is worn. In some versions of the invention, both of the fastening components attached to the main body of the respirator also serve as exhalation vents.

In other versions of the invention, one end of a strap may be integrally attached to one side of the main body of the respirator, with the other end of the strap terminating in strap fastening component capable of releasably engaging a corresponding fastening component attached to the main body of the respirator.

Generally, a strap assembly that is adapted to be used with a respirator comprises a strap; a strap fastening component attached to the strap; and a fastening component that is adapted to both attach to the main body of the respirator, and to releasably engage the strap fastening component. Representative examples of straps, strap fastening components, and fastening components adapted to attach to the main body of the respirator are referred to elsewhere in this disclosure. And, as is described elsewhere, the fastening component can comprise an exhalation vent. It should be noted that in some versions of the present invention, the end of the strap itself is threaded through, for example, a pull-strap assembly or other connecter that is attached to the main body of the respirator, i, the fastening component attached to the respirator is adapted to releasably engage the strap material itself without the strap terminating in a separate strap fastening component, such as a substantially rigid plastic component.

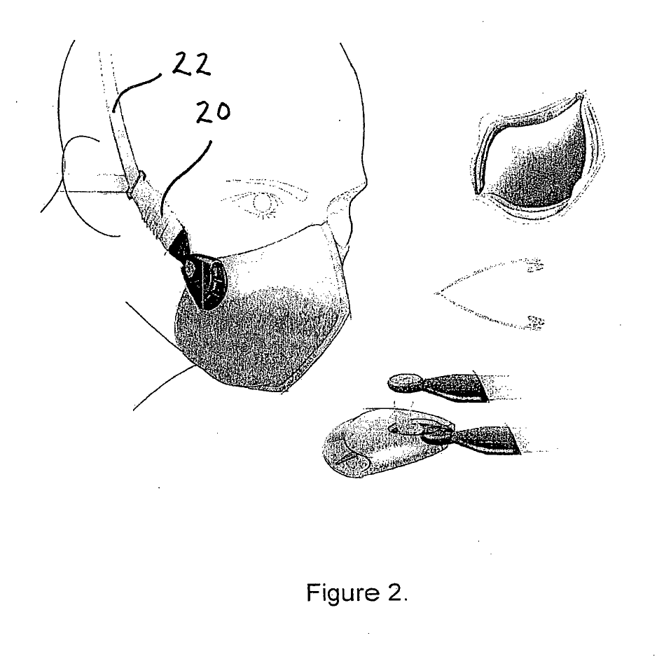

In some versions of the invention, a strap comprises a bellows-like device 20 as depicted in FIG. 2. The bellows-like device may comprise elastomeric material. Also, the bellows-like device may be adapted to mechanically extend by virtue of its accordion-like design. Any mechanical and/or elastomeric extension of the bellows-like device may be selected so that it responds to tension differently than the strap itself, i.e., the bellows-like device may be selected so that it is more or less extensible than the strap itself when exposed to various forces (such as forces creating tension). The bellows-like device can facilitate comfort and adjustability. Furthermore, such devices can provide for aesthetic appeal for certain potential customers of said respirators, such as customers who engage in sports, home-improvement, or myriad other activities in which respirators are worn. Also, a manufacturer or seller of such respirators can associate a brand name or trademark to respirators featuring such a bellows-like device (and/or other features described in this application). Furthermore, the color of the bellows-like device can be selected to provide for increased aesthetic appeal of the respirator. For example, the bellows-like device may be made with of plastic or other material having an orange color, while the remainder of the strap is of a different color (e.g., black). But it should be understood that other color combinations may be chosen to provide for aesthetic appeal (including matching the color of the bellows-like device and the remainder of the strap). It should also be noted that colors may be selected that convey information to a wearer, or those around the wearer, of certain safety ratings, or other standards, whether defined by a government or other organization, or the manufacturer or seller of the respirator.

The bellows-like device 20 depicted in FIG. 2 is one example of a mechanical or elastomeric component different than the main portion of the strap itself. Other such components may be selected, especially where the strap system is adapted to provide portions that respond to external forces differently (i.e., one portion of the strap, such as an elastomeric nonwoven material, responds to tension different than the bellows-like device or other component). For example, the strap could comprise a more rigid strap fastening component proximate to its end, a first discrete length of a first nonwoven material having a first elasticity, and a second discrete length of a second nonwoven material having a second elasticity. Or, for example, the bellows-like device 20 in FIG. 2 could be replaced by a discrete length of a nonwoven or other material having a different elasticity than the remaining portions of the strap 22.

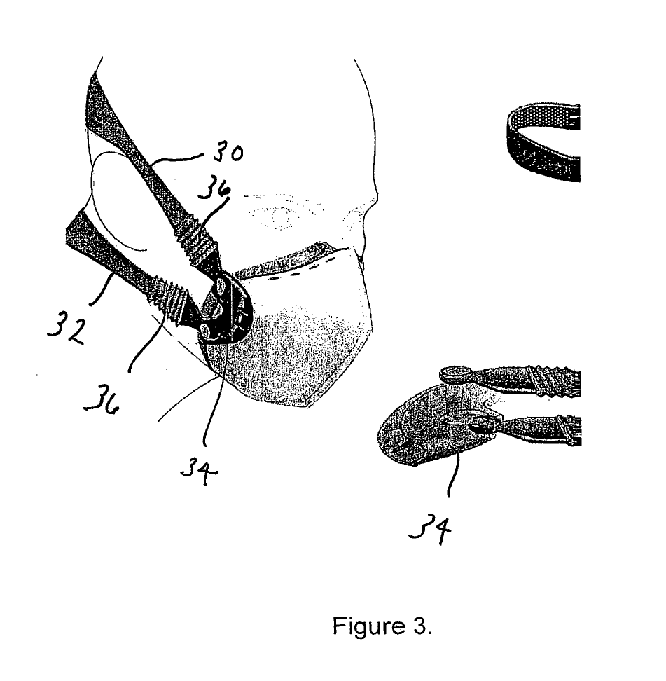

In some versions of the present invention, like that representatively depicted in FIG. 3, two straps 30 and 32 each comprise strap fastening components that can releasably engage a corresponding fastening component 34 attached to the main body of the respirator. The representative version depicted in FIG. 3 also depicts two optional strap components 36, in this case bellows-like devices, proximate to the strap fastening components. In the depicted version of the invention, the fastening components 34 attached to the main body of the respirator also serve as exhalation vents, as indicated by the ports or channels. While the depicted version shows two straps, the straps could constitute one assembly (e.g., with the upper and lower strap attached in the back—e.g., resembling a sideways letter “H” in the back by virtue of the upper and lower straps being connected in some way). Note too, as mentioned above, that the width of the strap can be selected so that the straps tend to stay in place, rather than rolling. To further aid in minimizing movement of the straps, the strap can comprise materials or elements that have sufficient friction when resting against the scalp, hair, skin, or some combination thereof, such that the straps have a greater tendency not to move. Also, as is noted below, the strap can comprise materials that tend to make the strap “breathable”; i.e., allow the passage of water vapor. One approach is to add particulates to polymeric materials used to form a nonwoven that will, in whole or in part, make up a strap. Note also that the strap fastening component attached to the main body of the respirator need not be a single assembly. Instead, two separate fastening components, each resembling fastening component 8 depicted FIG. 1, could be attached to each side of the main body of the respirator.

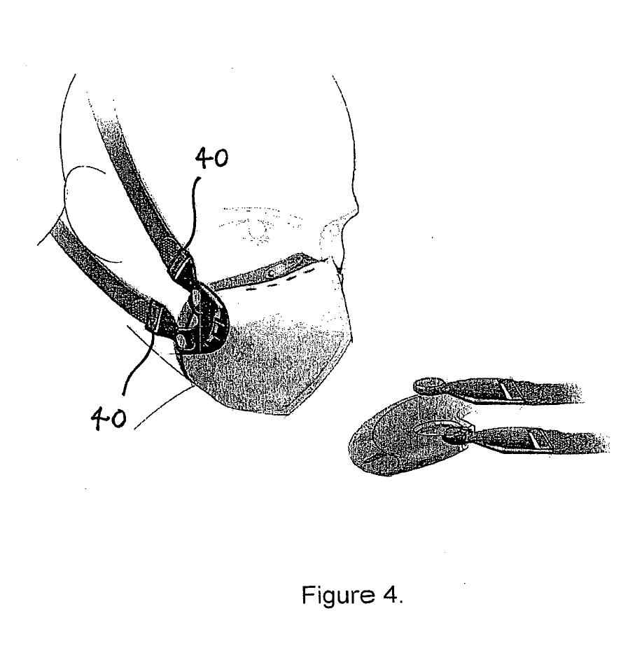

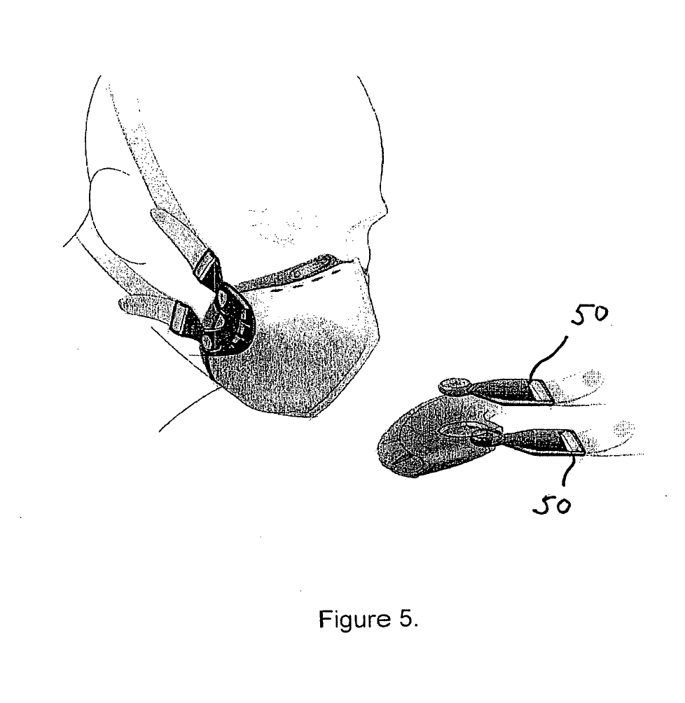

Another representative version, depicted in FIG. 4, depicts the main body of the respirator connected to two separate straps using strap fastening components similar to that described above. In this embodiment, the straps further comprise a pull-strap assembly 40 that allows for additional flexibility in adjusting the straps. FIG. 5 depicts a similar version of the present invention, again with pull-strap assemblies 50. In effect, the strap is not integrally attached to the strap fastening component (which comprises a pull-strap assembly adapted to releasably engage the strap itself).

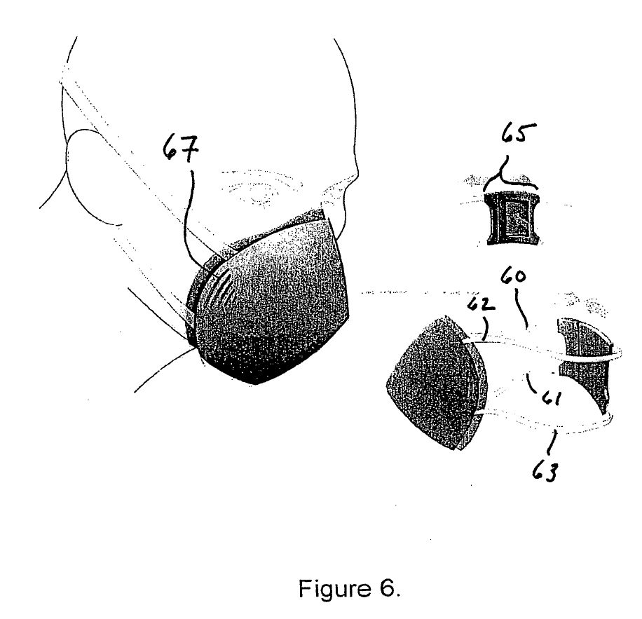

In another representative version of the present invention, as depicted in FIG. 6, straps 60, 61, 62, and 63 are integrally connected to the main body of the respirator. Each pair of straps are connected to a subassembly, the subassemblies combining to releasbly engage one another at a location proximate to the rear of the head of a wearer of the respirator when the respirator is being worn, as with the depicted buckle 65. In the depicted version of the invention, the main body of the respirator comprises exhalation vents 67 that are not integral with a fastening component.

In some versions of the present invention, the main body of the respirator is adapted to assume a planar configuration during shipment or storage, but which may be opened-up, unfolded, or otherwise deployed at the time of use such that the main body is adapted to fit over some portion of the face of a user.

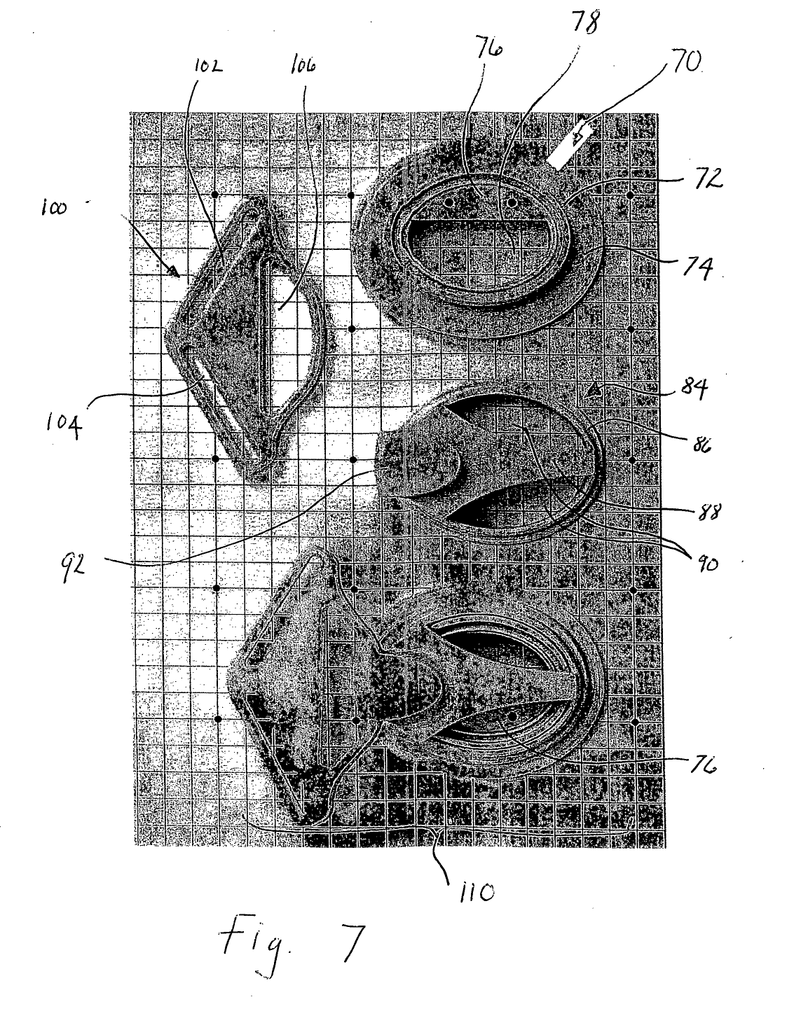

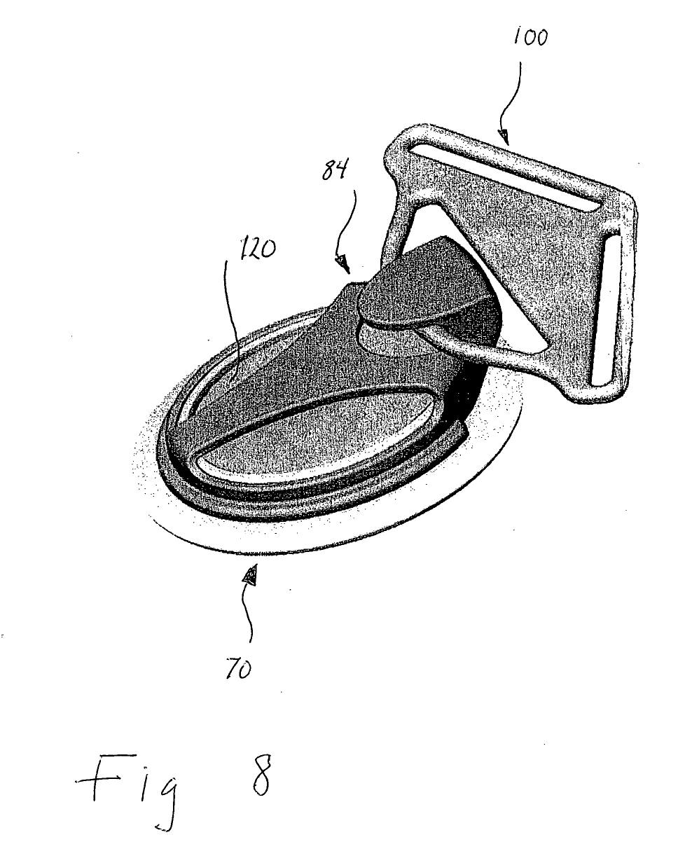

In other versions of the present invention, an exhalation vent assembly like that depicted in FIGS. 7 and 8 is employed with a respirator of the present invention. FIG. 7 depicts different components of this version of an exhalation-vent assembly. The inner vent body 70 in this representative version has an oval shape, but other shapes are possible (e.g., circular, etc.). The inner vent body is attached to, or is placed adjacent to, the inner surface of the main body of the respirator. In one version of the present invention, the main body of the respirator would be pre-cut to have an opening through which a portion of the inner vent body is inserted. For example, this opening may be placed at a location proximate to the perimeter of the main body near the ear of a wearer of the respirator (e.g., similar in location to where the fastening component 8 in FIG. 1 is located). While the strap may be integrally attached to one side of the respirator, and releasably attached to the other side of the respirator, in some versions of the present invention an exhalation vent assembly like the representative version depicted in FIGS. 7 and 8 may be attached to both sides of the respirator (the assembly includes a fastening component to which a strap fastening component may be releasably engaged). In versions such as this, the respirator may have a pre-cut opening on both sides of the respirator's main body, thereby allowing an exhalation vent to be attached to both sides of the main body of the respirator.

For the inner vent body 70 depicted in FIG. 7, the inner vent body rim 72, which protrudes upward from the inner vent body, may be inserted through the pre-cut opening in the main body of the respirator, with the edge portion 74 resting adjacent to at least some portion of the inner surface of the main body of the respirator. Attached to the rim 72 is a ledge 76, which generally serves to (1) help direct the flow of exhaled air (by blocking some portion of the opening 78 through which air proceeds), and/or (2) may serve, at least in part, as the point of attachment of a membrane (e.g., a film, substrate, or composite) that impedes or stops air from being drawn through the exhalation vent when a person is inhaling, but which allows air to be directed out through the exhalation vent when a person is exhaling. For example, a membrane that completely covers the opening 78, and which is attached only to the ledge 76, can operate as a movable flap that is pulled against the perimeter of the opening 78 when a person using the respirator inhales, thus stopping or impeding inward air flow (and thereby gaining the benefit of having inhaled air pass through the material used to make the main body of the respirator); but which, when a user of the respirator exhales, is pushed away from the perimeter of the opening to which the flap is not attached, thereby allowing air to pass out through the opening in the exhalation vent.

The inner vent body 70 will generally be shaped, and/or incorporate features, so that it can engage and/or mate with the outer vent body 84. So, in the representative version of an exhalation vent depicted in FIG. 7, the outer vent body 84 comprises an outer vent body rim 86 that fits around, and engages, the inner vent body rim 72. Furthermore, the rims can be designed to mechanically engage each other such that the inner- and outer vent bodies do not readily disengage from one another during use of the respirator. For example, the rims of the inner- and outer-vent bodies may comprise flange-like structures that snap into place when the outer vent body is placed over, and pushed down onto, the inner vent body (similar to, for example, a snap-on fastener). Many such mechanical connections are known and may be employed for this purpose. Other methods may be used to attach the inner- and outer vent bodies to one another, and to the main body of the respirator (e.g., using an adhesive, welding, thermal bonding, etc.).

The representative version of an outer vent body 84 depicted in FIG. 7 also comprises a divider 88 that basically splits the outer vent body opening into two separate air channels 90. Depending on the orientation of the inner vent body 70, and whether the inner vent body ledge 76 at least partially covers the upper or lower air channel 90, a user or manufacturer can direct exhaled air (at least some portion thereof) in a desired direction.

Note that a divider need not be present. Or other configurations or geometries may be used so that a manufacturer or user can choose to attach the components of the exhalation vent assembly such that exhaled air, or some portion thereof, is channeled in a desired direction (e.g., away from eyes where, if a user of the respirator is also wearing glasses or other eye protection, warm, humid air may condense on eyeglass or eye-protection surfaces, thereby making it more difficult to see).

The representative version of an exhalation vent assembly depicted in FIG. 7 also comprises a strap fastening component 100. The representative version 100 depicted in FIG. 7 generally possesses a triangular shape, with two rectangular slots 102 and 104 adapted to each receive straps. The strap fastening component also comprises an opening 106 adapted to releasably engage the outer vent body 84, which, in the representative version depicted in FIG. 7, employs a cantilevered hook as a fastening component 92 to engage the aforementioned opening on the strap fastening component.

The three components are engaged to one another in the combined exhalation vent assembly 110. It should be noted that the inner vent body ledge 76, which was oriented upward in the FIG. 7's depiction of the separate component 70, is oriented downward in the combined assembly 110. It should also be noted that the membrane referred to above is not shown in FIG. 7. It should also be noted that FIG. 7's depiction of the combined assembly does not show the main body of the respirator, or portions thereof, which would of course be—at least in part—sandwiched between portions of the inner- and outer-vent bodies.

FIG. 8 provides another view of the exhalation vent assembly, in this case with a membrane 120 also shown. As in the previous figure, inner vent body 70 is attached to outer vent body 84, which in turn is releasably connected to the strap attachment fastener 100. As discussed above, the membrane is attached to a portion of the inner vent body so that some portion of the membrane is free to move when pressure/force is exerted on the inner surface of the membrane by virtue of a user exhaling. And, as noted above, the membrane is drawn against the perimeter of the inner vent body when a user inhales, thereby stopping or impeding the flow of air inward to the space between the inner surface of the main body of the respirator and a user's face when the user inhales.

Typically the components depicted in FIGS. 7 and 8 are made of substantially rigid materials such as plastics, metal, and the like.

In some versions of the present invention, the perimeter of the main body of the respirator proximate to the eyes of a wearer is contoured to facilitate the wearer's choice to employ eyewear. Furthermore, one or more versions of the present invention may include components that facilitate attraction or attachment of a portion of any conventional or specially adapted eyewear to some portion of the respirator. For example, some portion of the perimeter of the respirator proximate to the eyes of a wearer may comprise magnets, adhesive, or other mechanical fastening systems adapted to releasably engage at least a portion of the eyewear. In some versions of the invention, eyewear is integrally attached to the main body of the respirator.

It should be noted that in some versions of the present invention, a material is placed around at least a portion of the surface of the main body of the respirator that is adapted to face inward toward the skin of the wearer (e.g., comfort seals such as Hydra-gel, foams, or similar materials incorporated around the periphery of the respirator (at the respirator/wearer interface); or adhesive sealants to improve peripheral seal and respirator performance).

In some versions of the invention, the respirator, strap, or other component incorporates a sensor adapted to detect or measure some variable, such as the passage of time, or the accumulation of a constituent of the air or gas being breathed or exhaled, or temperature, or humidity, or some other such variable, or some combination thereof; and then provide a signal to an information device such as a computer; or a wearer; or other such receiver of the signal. The signal could be tactile, visual, audible, olfactory, or some other sensory effect. The sensor and signal may be something as simple as a color-change indicator attached to the respirator or strap. Or the sensor may be operatively connected to another device capable of receiving, storing, processing, displaying, and transmitting information—whether the device is attached to, or separate from, the respirator.

In other versions of the invention, a portion of the main body of the respirator may be transparent to facilitate recognition by others of the identity of the wearer of the respirator.

In other versions of the invention, the straps, respirator, or both may comprise cavities or channels in fluid communication with a mechanical or motorized pumping device, whether attached to (e.g., mechanical air pumps used to inflate portions of an athletic shoe) or separate from the respirator, such that the fit of the respirator can be adjusted by adding or releasing air from the cavities and/or channels. In some versions of the invention, the fluid may be water, or some other liquid.

The strap may comprise woven, nowoven, rubber, plastic, or other materials. Similarly, the main body of the respirator can comprise many of these same materials. Examples of one or more materials used in respirators and/or facemasks are disclosed in U.S. Pat. No. 5,322,061; which is dated June 21, 1994, and is entitled “Disposable Aerosol Mask” to Kevin K. Branson; and which is hereby incorporated by reference in its entirety in a manner consistent herewith; as well as in the references cited elsewhere in this disclosure, including those references cited in the Definitions section for various kinds of substrates and materials. Generally the selected materials by which the main body of the respirator is constructed are cut, slit, or otherwise configured into forms adapted to cover portions of a user's face (e.g., the nose and mouth of a user). If individual layers or components need be attached to one another to make the main body of the respirator, then said layers or components may be attached to one another using, for example, heat, adhesives, ultrasonic energy, mechanical attachment devices (e.g., hook-and-loop fasteners), sewing, and the like. As noted elsewhere, the materials may be pre-cut in some way to facilitate attachment to a fastening component.

For elastomeric characteristics, the strap may be made using suitable elastomeric fiber-forming resins or blends containing the same. For example, the strap may be made from block copolymers having the general formula A-B-A′ where A and A′ are each a thermoplastic polymer endblock which contains a styrenic moiety such as a poly (vinyl arene) and where B is an elastomeric polymer midblock such as a conjugated diene or a lower alkene polymer. The block copolymers may be, for example, (polystyrene/poly(ethylene-butylene)/polystyrene) block copolymers available from the Shell Chemical Company under the trademark KRATON. G. One such block copolymer may be, for example, KRATON G-1657.

Other exemplary materials which may be used include polyurethane materials such as, for example, those available under the trademark ESTANE from B. F. Goodrich & Co., polyamide materials such as, for example, those available under the trademark PEBAX from the Rilsan Company, and polyester materials such as, for example, those available under the trade designation Hytrel from E. I. DuPont De Nemours & Company. Formation of meltblown fibers from polyester materials is disclosed in, for example, U.S. Pat. No. 4,741,949 to Morman et al., which is hereby incorporated by reference in its entirety in a manner consistent herewith. Useful polymers also include, for example, copolymers of ethylene and at least one vinyl monomer such as, for example, vinyl acetates, unsaturated aliphatic monocarboxylic acids, and esters of such monocarboxylic acids. The copolymers and formation of meltblown fibers from those copolymers are disclosed in, for example, U.S. Pat. No. 4,803,117.

Processing aids may be added to the polymer. For example, a polyolefin may be blended with the polymer (e.g., the A-B-A elastomeric block copolymer) to improve the processability of the composition. The polyolefin must be one which, when so blended and subjected to an appropriate combination of elevated pressure and elevated temperature conditions, extrudable, in blended form, with the polymer. Useful blending polyolefin materials include, for example, polyethylene, polypropylene and polybutene, including ethylene copolymers, propylene copolymers and butene copolymers. A particularly useful polyethylene may be obtained from the U.S.I. Chemical Company under the trade designation Petrothene NA 601 (also referred to herein as PE NA 601 or polyethylene NA 601). Two or more of the polyolefins may be utilized. Extrudable blends of polymers and polyolefins are disclosed in, for example, previously referenced U.S. Pat. No. 4,663,220.

Desirably, the strap should have some tackiness or adhesiveness to enhance autogenous bonding. In regard to the tackifying resins and tackified extrudable compositions, note the resins and compositions as disclosed in U.S. Pat. No. 4,787,699, hereby incorporated by reference in its entirety in a manner consistent herewith.

If employed, a tackifier resin can be used which is compatible with the polymer and can withstand the processing (e.g., extrusion) temperatures. If the polymer (e.g., A-B-A elastomeric block copolymer) is blended with processing aids such as, for example, polyolefins or extending oils, the tackifier resin should also be compatible with those processing aids. Generally, hydrogenated hydrocarbon resins are preferred tackifying resins, because of their better temperature stability. REGALREZ and ARKON series tackifiers are examples of hydrogenated hydrocarbon resins. ZONATAK 501 lite is an example of a terpene hydrocarbon. REGALREZ hydrocarbon resins are available from Hercules incorporated. ARKON series resins are available from Arakawa Chemical (U.S.A.) Incorporated. Of course, the present invention is not limited to use of such three tackifying resins, and other tackifying resins which are compatible with the other components of the composition and can withstand the processing temperatures, can also be used.

If a tackifier resin is employed, then the blend typically used to form the strap or portions thereof include, for example, from about 40 to about 80 percent by weight polymer, from about 5 to about 40 percent polyolefin and from about 5 to about 40 percent resin tackifier. For example, a particularly useful composition included, by weight, about 61 to about 65 percent KRATON G-1657, about 17 to about 23 percent polyethylene NA 601, and about 15 to about 20 percent REGALREZ 1126.

The strap of the present invention may be a mixture of elastic and nonelastic fibers or particulates. For an example of such a mixture, reference is made to U.S. Pat. No. 4,209,563, which is hereby incorporated by reference in its entirety in a manner consistent herewith, in which elastomeric and non-elastomeric fibers are commingled to form a single coherent web of randomly dispersed fibers. Another example of such an composite web would be one made by a technique such as disclosed in previously referenced U.S. Pat. No. 4,741,949. That patent discloses an elastic nonwoven material which includes a mixture of meltblown thermoplastic fibers and other materials. The fibers and other materials are combined in the gas stream in which the meltblown fibers are borne so that an intimate entangled commingling of meltblown fibers and other materials, e.g., wood pulp, staple fibers or particulates such as, for example, activated charcoal, clays, starches, or hydrocolloid (hydrogel) particulates commonly referred to as super-absorbents occurs prior to collection of the fibers upon a collecting device to form a coherent web of randomly dispersed fibers.

Other polymers useful in the manufacture of the strap may further include thermoplastic polymers like polyolefins, polyesters and polyamides. Elastic polymers may also be used and include block copolymers such as polyurethanes, copolyether esters, polyamide polyether block copolymers, ethylene vinyl acetates (EVA), block copolymers having the general formula A-B-A′ or A-B like copoly(styrene/ethylene-butylene), styrene-poly(ethylene-propylene)-styrene, styrene-poly(ethylene-butylene)-styrene, (polystyrene/poly(ethylene-butylene)/polystyrene, poly(styrene/ethylene-butylene/styrene) and the like.

Polyolefins using single site catalysts, sometimes referred to as metallocene catalysts, may also be used to make the strap. Many polyolefins are available for fiber production, for example polyethylenes such as Dow Chemical's ASPUN7 6811A linear low density polyethylene, 2553 LLDPE and 25355 and 12350 high density polyethylene are such suitable polymers. The polyethylenes have melt flow rates, respectively, of about 26, 40, 25 and 12. Fiber forming polypropylenes include Exxon Chemical Company's 3155 polypropylene and Montell Chemical Co.'s PF-304 and/or PF-015. Many other polyolefins are commercially available.

Biodegradable polymers are also available for making the strap and suitable polymers include polylactic acid (PLA) and a blend of BIONOLLE, adipic acid and UNITHOX (BAU). PLA is not a blend but a pure polymer like polypropylene. BAU represents a blend of BIONOLLE, adipic acid, and UNITHOX at different percentages. Typically, the blend for staple fiber is 44.1 percent BIONOLLE 1020, 44.1 percent BIONOLLE 3020, 9.8 percent adipic acid and 2 percent UNITHOX 480, though spunbond BAU fibers typically use about 15 percent adipic acid. BIONOLLE 1020 is polybutylene succinate, BIONOLLE 3020 is polybutylene succinate adipate copolymer, and UNITHOX 480 is an ethoxylated alcohol. BIONOLLE is a trademark of Showa Highpolymer Co. of Japan. UNITHOX is a trademark of Baker Petrolite which is a subsidiary of Baker Hughes International.

As noted above, the strap can comprise elastomeric materials, such as a stretch-bonded laminate (SBL). In another version of the present invention, the strap can comprise an elastomeric film, or individual elastic components, such as elastic strands (e.g., individual elastic strands may be extruded or formed such that they are spaced apart and substantially parallel, and to these strands may be attached meltblown or other fiber).

Also, as noted above, the upper periphery of the respirator can comprise materials or components adapted to interact with eyewear. For example, a ferrous or other magnetic inner wire may be employed proximate to the upper perimeter of the respirator. This wire can interact with any magnet employed in eyewear. Furthermore, the wire can be flexed or adjusted to customize the fit of the respirator and/or eyewear, helping prevent the safety glasses from sliding off the face or moving around the contour of the respirator.

As noted elsewhere, the respirator may be disposable. For example, the entire respirator (e.g., in one representative version, comprising a main body; a strap comprising strap fastening components; and fastening components attached to the main body, and adapted to releasably engage the strap fastening components) may be disposable (e.g., after a single use, or limited use).

The manufacturer or distributor of a respirator of the present invention may fashion messages, statements, or copy to be transmitted to a purchaser, consumer, or user of said respirator. Such messages, statements, or copy may be fashioned to help facilitate or establish an association in the mind of a user of the respirator between a respirator of the present invention, or use thereof, and one or more mental states, psychological states, or states of well being. The communication, statements, or copy may include various alphanumeric strings, including, for example: disposable, convenience, ease, ease of use, comfort, safety, motocross, X-sports, maintenance, repair, cyclocross, skateboarding, snowboarding, healthcare, operating, surgical, and derivatives or combinations thereof, or other such words or states. In one embodiment, the communication, statements, or copy associate a respirator of the present invention and ease of donning. In another embodiment, the communication, statements, or copy associate a respirator of the present invention and disposability. In another embodiment, the communication, statements, or copy associate a respirator of the present invention and a registered or common-law trademark of the seller, manufacturer, and/or distributor of the appliance. For example, a statement could be disposed in or on a container containing a respirator of the present invention that associates the respirator with a logo or brand name or manufacturer such as Kimberly-Clark, Kimberly-Clark Professional, Kleenguard®, 3M, Moldex, Gerson, some other logo or brand name or manufacturer or seller of respirators, or combinations thereof.

Messages, copy, statements, and/or alphanumeric strings like those referred to above may be used either alone, adjacent to, or in combination with, other alphanumeric strings. The communication, statements, message, or copy could take the form of (i.e., be embodied in a tangible medium such as) a newspaper advertisement, a television advertisement, a radio or other audio advertisement, items mailed directly to addressees, items emailed to addresses, Internet Web pages or other such postings, free standing inserts, coupons, various promotions (e.g., trade promotions), co-promotions with other companies, copy and the like, boxes and packages containing the product (in this case a respirator of the present invention), and other such forms of disseminating information to consumers or potential consumers. For example, a message embodied in a tangible medium could associate a respirator of the present invention with a logo or brand name or manufacturer such as Kimberly-Clark, Kimberly-Clark Professional, Kleenguard®, 3M, Moldex, Gerson, some other logo or brand name or manufacturer or seller of respirators, or combinations thereof.

It should be noted that when associating statements, copy, messages, or other communications with a package (e.g., by printing text, images, symbols, graphics, color(s), or the like on the package; or by placing printed instructions in the package; or by associating or attaching such instructions, a coupon, or other materials to the package; or the like) containing one or more respirators of the present invention, the materials of construction of said package may be selected to reduce, impede, or eliminate the passage of water or water vapor through at least a portion of the package. Furthermore, the materials of construction of said package may be selected to minimize or impede the passage of light through said package, including minimizing or impeding the passage of electromagnetic waves of a selected wavelength or wavelengths.

Furthermore, respirators may be individually wrapped in containers, packets, envelopes, bags, wrappers, or the like that inhibit, reduce, or eliminate the passage or transmission of water or water vapor. For purposes of this application, “packages,” “containers,” “envelopes,” “bags,” “packets,” and the like are interchangeable in the sense that they refer to any material adapted to enclose and hold either individual respirators (as in, for example, an individual package containing a single respirator), or a plurality of respirators (as in a flexible bag made of film or plastic container containing a plurality of respirators, whether or not each of the individual respirators are enclosed and held in a separate material—such as individual packages).

In some embodiments of the present invention, a package will contain not only one or more respirators of the present invention, but other health-and-hygiene products. In one embodiment, a respirator of the present invention is sold, transferred, distributed, or marketed with eyewear, especially eyewear adapted to attach, adhere, or be attracted to (e.g., via magnetic interactions) at least a portion of the respirator. It should be noted that such combinations may be marketed and packaged as described in the preceding paragraphs. It should also be noted that statements on packages, messages embodied in tangible media, and packages like those described in this paragraph may be associated with the brand name or logo of a private-label brand (meaning that a product or article of manufacture, like a respirator of the present invention, is made by one company for sale under the logo or brand name of another company—often the logo or brand name of a retailer or distributor).

Reference now will be made to various embodiments of the invention, examples of which are set forth below. Each example is provided by way of explanation of the invention, not as a limitation of the invention. In fact, it will be apparent to those skilled in the art that various modifications and variations can be made of this invention without departing from the scope or spirit of the invention.

1-25. (canceled)

26. A strap assembly adapted to be used with a respirator, the strap assembly comprising:
a strap;
a strap fastening component attached to the strap; and
a fastening component comprising an exhalation vent, wherein the fastening component is adapted to releasably engage the strap fastening component, and wherein the fastening component is adapted to attach to a main body of a respirator.

27.-28. (canceled)

29. The strap assembly of claim 26 wherein the strap comprises a Y-shaped juncture.

30. A strap assembly adapted to be used with a respirator, the strap assembly comprising:
a strap; and
a fastening component comprising an exhalation vent, wherein the fastening component is adapted to releasably engage the strap, and wherein the fastening component is adapted to attach to a main body of a respirator.

31-32. (canceled)

33. The strap assembly of claim 30 wherein the strap comprises a Y-shaped juncture.

34. The strap assembly of claim 26 wherein the fastening component is substantially rigid.

35. The strap assembly of claim 26 wherein the strap fastening component is sustantially rigid.

36. The strap assembly of claim 26 wherein the main body of the respirator is adapted to be substantially flat during shipping.

37. The strap assembly of claim 26 wherein the fastening component comprises a post, and wherein the strap fastening component comprises an opening adapted to fit over the post.

38. The strap assembly of claim 26 whereIn the fastening component comprises a post, and wherein the strap fastening component comprises a snap adapted to fit over the post.

39. The strap assembly of claim 26 wherein the strap is connected to a pull-strap assembly.

40. The strap assembly of claim 26 wherein the strap splits to form two Y-shaped portions, the Y-shaped portions being adapted to be positioned at a location proximate to the front of a user's ears.

41. The strap assembly of claim 26 further comprising a second strap, the second strap comprising a second strap fastening component adapted to releasably engage the fastening component attached to said main body.

42. The strap assembly of daim 26 wherein the strap fastening component defines a strap fastening component opening, the fastening component Is a hook, and the strap fastening component opening is adapted to releasably engage the hook.

43. The strap assembly of claim 30 wherein the fastening component is substantIally rigid.

44. The strap assembly of claim 30 wherein the main body of the respirator is adapted to be substantially flat during shipping.

45. The strap assembly of claim 30 wherein the strap is connected to a pull-strap assembly.

46. The strap assembly of claim 30 wherein the strap splits to form two Y-shaped portions, the Y-shaped portions being adapted to be positioned at a location proximate to the front of a users ears.
